(19) United States
(12) Patent Application Publication
(10) Pub. No.: US 2003/0154385 A1
(43) Pub. Date: Aug. 14, 2003

(54) Data security device of data storage medium

(76) Inventor: Pei-Chung Liu, ChungHo City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/072,929

(22) Filed: Feb. 12, 2002

(51) Int. Cl. G06F 12/14

(52) U.S. Cl. 713/193

(57) ABSTRACT

A data security device for data storage medium includes a USB mass storage class controller connected to an operation system, such as a personal computer, and a data protection device connecting the USB mass storage class controller to a data storage medium. The data security device may be incorporated in a USB-based data accessing device and can be activated by a user via the operation system. The data protection device includes a write protection unit which provides write protection to the data storage medium when data are to be written by the operation system to the data storage medium, an enciphering unit which enciphers data written into the data storage medium and a deciphering unit which deciphers the enciphered data stored in the data storage medium when the operation system retrieves data from the data storage medium.

### BACKGROUND OF THE INVENTION

1. Field of the Invention

The present invention relates generally to a data security device, and in particular to a data security device to be incorporated in a USB-based data accessing device for protecting data stored in a data storage medium accessible by the data accessing device.

2. The Related Art

Storage media for mass storage of data, such as compact flash (CF) card, multi-media card (MMC), memory stick, smart media card and security digital (SD) card, are widely used for storage of a great amount of data. An illustrative application of the mass data storage media is digital cameras. In writing/reading data into/from the mass data storage media, a data accessing device, such as a card reader, is employed to access (read/write) the data. This provides an efficient manner to store/retrieve data into/from the mass data storage media. However, heretofore, the data accessing device of the mass data storage media is not provided with any means for preventing data stored in the mass data storage media from being accidentally erased or overwritten.

In addition, the data stored in the mass data storage media can be accessed readily by a suitable card reading device. No security means is provided for enciphering and preventing unauthorized access of the data stored in the mass data storage media.

One way to solve the above problems is to add security features to the data storage medium itself. This, however, requires modification of the data storage medium which is in general difficult. In addition, modification of a data accessing device for properly reading/writing the modified data storage medium is also required. Compatibility between modified and non-modified data storage media is another concern that needs to be addressed. Thus, adding security features to the data storage medium directly is generally impractical.

### SUMMARY OF THE INVENTION

An object of the present invention is thus to provide a separate data security device for protecting data stored in a data storage medium from being accidentally damaged without modification of the data storage medium and data accessing devices available in the market.

Another object of the present invention is to provide a data security device comprising a write protection unit capable to be activated by a user via a computer to prevent the data stored in a data storage medium from being erased and overwritten.

A further object of the present invention is to provide a data security device comprising an enciphering unit capable to be activated by a user via a computer to encipher data to be written into a data storage medium.

Yet a further object of the present invention is to provide a data security device comprising a deciphering unit capable to be activated by a user via a computer to retrieve enciphered data from a data storage medium.

To achieve the above objects, in accordance with the present invention, there is provided a USB-based data security device for data storage medium. The data security device comprises a USB mass storage class controller connected to an operation system, such as a personal computer, and a data protection device connecting the USB mass storage class controller to a data storage medium. The data security device may be incorporated in a USB-based data accessing device and can be activated by a user via the operation system. The data protection device comprises a write protection unit which provides write protection to the data storage medium when data are to be written by the operation system to the data storage medium, an enciphering unit which enciphers data written into the data storage medium and a deciphering unit which deciphers enciphered data stored in the data storage medium when the operation system retrieves data from the data storage medium.

### BRIEF DESCRIPTION OF THE DRAWINGS

The present invention will be apparent to those skilled in the art by reading the following description of a preferred embodiment thereof, with reference to the attached drawings, in which:

FIG. 1 is a block diagram of a data security device constructed in accordance with the present invention;

FIG. 2 is a flow chart of a write protection operation performed by the data security device of the present invention;

FIG. 3 is a flow chart of an enciphering operation performed by the data security device of the present invention;

FIG. 4 is a flow chart of a deciphering operation performed by the data security device of the present invention; and

FIG. 5 is a schematic view showing an application of the data security device of the present invention in a computer system.

### DETAILED DESCRIPTION OF THE PREFERRED EMBODIMENT

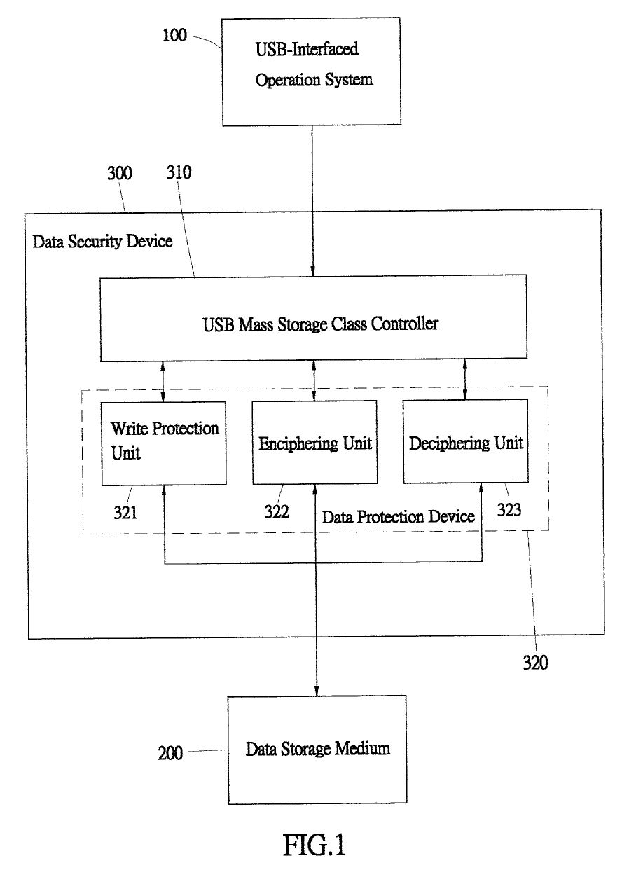

With reference to the drawings and in particular to FIG. 1, a data security device in accordance with the present invention, generally designated with reference numeral 300, is arranged between a USB-interfaced operation system 100 and a data storage medium 200. The USB-interfaced operation system 100 can be any operating device or platform, such as a desktop computer and a notebook computer, that has a USB interface. The data storage medium 200 can be any storage medium that can store a great amount of data. Examples of the data storage medium 200 include compact flash (CF) card, multi-media card (MMC), memory stick, smart media and security digital (SD) card, but not limited thereto.

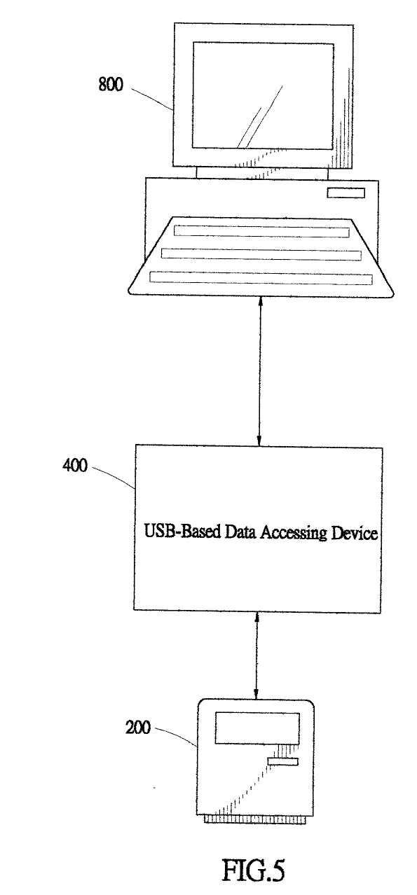

The data security device 300 of the present invention is arranged or incorporated in a USB-based data accessing device 400 (FIG. 5), such as a card reader for reading/writing a CF card or the likes. The data security device 300 comprises a USB mass storage class controller 310 and a data protection device 320. The USB mass storage class controller 310 is operated in accordance with BULK-ONLY or CBI protocol defined in the specification of USB mass storage class to access (read/write) data between the operation system 100 and the data protection device 320 whereby when a data storage medium 200 is inserted into the data accessing device 400 for performing reading/writing operation, the data storage medium 200 is treated as a plug-and-play peripheral device, such as a plug-and-play hard disk drive or optic disk drive, by the operation system 100.

The data protection device 320 connects the USB mass storage class controller 310 to the data storage medium 200. The data protection device 320 comprises a write protection unit 321, an enciphering unit 322 and a deciphering unit 323. The write protection unit 321 is to provide write protection to the data storage medium 200. In other words, a user may issue a write protection command to the USB mass storage class controller 310 by means of the operation system 100. The write protect unit 321 is thus activated/de-activated to enable/disable write protection of the data storage medium 200.

The enciphering unit 322 enciphers data transmitted from the operation system 100 through the USB mass storage class controller 310 to the data storage medium 200 when the operation system 100 issues a write command to the USB mass storage class controller 310. Thus data written into the data storage medium 200 can be stored in an enciphered form.

The deciphering unit 323 functions to decipher the enciphered data stored in the data storage medium 200. When the operation system 100 issues a read command to the USB mass storage class controller 310, the USB mass storage class controller 310 determines first if the data stored in the data storage medium 200 are enciphered. If not, the data are transferred to the operation system 100 directly. If the data are enciphered, the deciphering unit 323 is activated to decipher the data and the deciphered data are then transferred to the operation system 100:

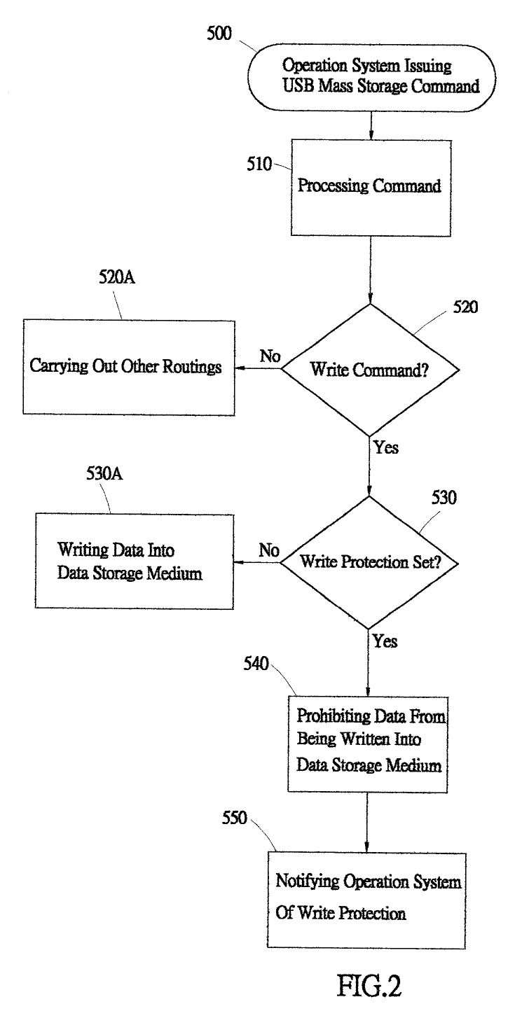

FIG. 2 shows the operation of the write protection unit 321 of the data protection device 320. The operation of write protection comprises the following steps:

In step 500, the operation system 100 issues a USB mass storage protocol based command. In step 510, the command is processed by the USB mass storage class controller 310. In step 520, it is determined if the command is a write command. If yes, then the operation flow goes to step 530, otherwise the flow goes to step 520A wherein other routings are performed. In step 530, it is determined if write protection is activated. If yes, then the operation flow goes to step 540, otherwise the operation flow goes to step 530A wherein data transmitted from the operation system 100 are written into the data storage medium 200. In step 540, data are prohibited from being written into the data storage medium 200. In step 550, the condition of write protection is sent back to the operation system 100.

It is understood from the above described steps 500-550 that the write protection unit 321 is activated by a user by means of the operation system 100 whereby when the data accessing device 400 is connected to another operation system 100, the write protection unit 321 prevents data from being written into the data storage medium 200.

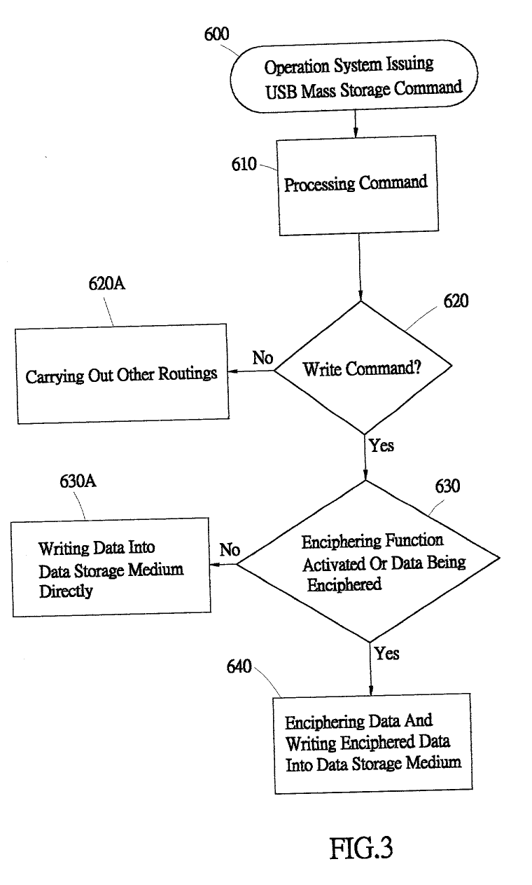

FIG. 3 shows the operation of the enciphering unit 322 of the data protection device 320. The operation comprises the followings steps:

In step 600, the operation system 100 issues a USB mass storage protocol based command. In step 610, the command is processed by the USB mass storage class controller 310 and then sent to the data protection device 320. In step 620, it is determined if the command is a write command. If yes, then the operation flow goes to step 630, otherwise the flow goes to step 620A wherein other routings are performed. In step 630, it is determined if the enciphering function is activated or if the data transmitted from the operation system 100 is enciphered already. If yes, then the operation flow goes to step 640, otherwise the operation flow goes to step 630A wherein data transmitted from the operation system 100 are written into the data storage medium 200. In step 640, the data are enciphered and then written into the data storage medium 200. Namely, the enciphering unit 322 enciphers the data transmitted from the operation system 100 and the enciphered data are then written into the data storage medium 200.

The above discussed procedure indicates that the enciphering unit 322 can be activated by a user through the operation system 100 whereby data can be enciphered.

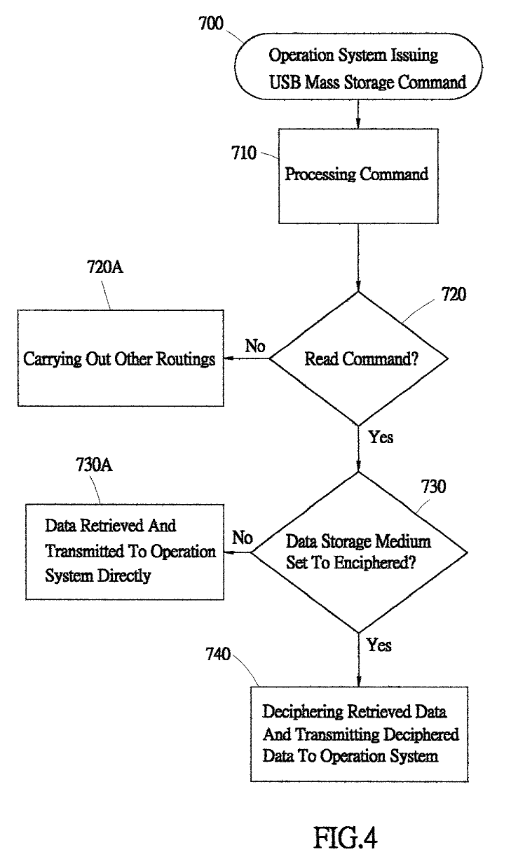

FIG. 4 shows the operation of the deciphering unit 323 of the data protection device 320. The operation comprises the following steps:

In step 700, the operation system 100 issues a USB mass storage protocol based command. In step 710, the command is processed by the USB mass storage class controller 310 and then sent to the data protection device 320. In step 720, it is determined if the command is a read command. If yes, then the operation flow goes to step 730, otherwise the flow goes to step 720A wherein other routings are performed. In step 730, it is determined if the data storage medium 200 is in enciphered condition. If yes, then the operation flow goes to step 740, otherwise the operation flow goes to step 730A wherein data in the data storage medium 200 is directly retrieved and transmitted to the operation system 100. In step 640, the data are deciphered and then transmitted to the operation system 100. Namely, the deciphering unit 323 deciphers the data retrieved from the data storage medium 200 first and the deciphered data are then transmitted to the operation system 100.

The above discussed procedure indicates the operation of reading enciphered data from the data storage medium 200.

Also referring to FIG. 5 which shows a practical application of the data security device 300 of the present invention. The data security device 300 is arranged/incorporated in a USB-based data accessing device 400 which in the embodiment illustrated is a USB-based card reader. The card reader can be connected to a computer system 800 via a USB interface. The computer system 800 is thus functioning as a operation system for activating functions of write protection, enciphering and deciphering for a data storage medium 200. An effective protection and security of the data stored in the data storage medium 200 can be readily achieved by means of the present invention.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A USB-based data security device comprising:
a USB mass storage class controller connected to a USB-interfaced operation system for carrying out USB protocol commands issued by the operation system; and
a data protection device connecting the USB mass storage class controller to a data storage device, the data protection device comprising a write protection unit, an enciphering unit and a deciphering unit, the write protection unit and the enciphering unit respectively providing write protection of the data storage medium and enciphering data when data are to be written by the operation system into the data storage medium, the deciphering unit deciphering data from the data storage medium when the operation system reads the data from the data storage medium.

2. The USB-based data security device as claimed in claim 1, wherein the USB mass storage class controller and the data protection device are incorporated in a USB-based data accessing device.

3. The USB-based data security device as claimed in claim 2, wherein the USB-based data accessing device comprises a USB-based card reader.

4. The USB-based data security device as claimed in claim 1, wherein the data storage medium comprises a compact flash card.

5. The USB-based data security device as claimed in claim 1, wherein the data storage medium comprises a multi-media card.

6. The USB-based data security device as claimed in claim 1, wherein the data storage medium comprises a memory stick.

7. The USB-based data security device as claimed in claim 1, wherein the data storage medium comprises a smart media card.

8. The USB-based data security device as claimed in claim 1, wherein the data storage medium comprises a security digital card.
